(19) United States
(12) Patent Application Publication
(10) Pub. No.: US 2011/0170233 A1
(43) Pub. Date: Jul. 14, 2011

(54) Chip-type electric double layer capacitor cell and method of manufacturing the same

(75) Inventors: Sung Ho Lee, Seongnam (KR); Chang Ryul Jung, Seoul (KR); Hyun Chul Jung, Yongin (KR); Yeong Su Cho, Guri (KR); Wan Suk Yang, Seoul (KR)

(73) Assignee: SAMSUNG ELECTRO-MECHANICS CO., LTD., Suwon (KR)

(21) Appl. No.: 12/801,920

(22) Filed: Jul. 1, 2010

(30) Foreign Application Priority Data
Jan. 12, 2010 (KR) 10-2010-0002880

(51) Int. Cl. H01G 9/016; H01G 9/155

(52) U.S. Cl. 361/502; 29/25.03

(57) ABSTRACT

There is provided a chip-type electric double layer capacitor cell and a method of manufacturing the same. The chip-type electric double layer capacitor cell includes a separator folded to include first and second folded portions with first and second open portions formed in opposite directions by the first and second folded portions, and first and second electrodes inserted into the first and second open portions. The positions of the first and second electrodes are fixed by the first and second folded portions of the separator, and accordingly, the appropriate arrangement of the plurality of first and second electrodes is facilitated. A short circuit between the first and second electrodes is avoided to thereby increase the capacitance of the chip-type electric double layer capacitor cell.

### CROSS-REFERENCE TO RELATED APPLICATIONS

This application claims the priority of Korean Patent Application No. 10-2010-0002880 filed on Jan. 12, 2010, in the Korean Intellectual Property Office, the disclosure of which is incorporated herein by reference.

### BACKGROUND OF THE INVENTION

1. Field of the Invention

The present invention relates to a chip-type electric double layer capacitor cell and a method of manufacturing the same, and more particularly, to a chip-type electric double layer capacitor cell facilitating the realization of increased capacitance and having high yield rate and a method of manufacturing the same.

2. Description of the Related Art

In various electronic products such as information communication devices, a stable energy supply is considered to be an important element. In general, such a function is performed by a capacitor. That is, the capacitor serves to store electricity in a circuit provided in various electronic products such as information communication devices and then discharge the electricity, thereby stabilizing the flow of electricity within the circuit. A general capacitor has a short charge and discharge time, a long lifespan, and high output density. However, since the general capacitor has low energy density, there is a limitation in using the capacitor as a storage device.

To overcome such a limitation, a new category of capacitors such as electric double layer capacitors have recently been developed, which have a short charge and discharge time and high output density. A great deal of attention is being paid to such capacitors as next generation energy devices together with secondary cells.

The electric double layer capacitor is an energy storage device using a pair of electrodes having different polarities. The electric double layer capacitor may perform continuous electrical charge and discharge cycles and have higher energy efficiency and output and greater durability and stability than other, more general capacitors. Accordingly, the electric double layer capacitor which may be charged and discharged with high current is being recognized as a storage device which may be charged and discharged at a high frequency, such as an auxiliary power supply for mobile phones, an auxiliary power supply for electric vehicles, and an auxiliary power supply for solar cells.

A basic structure of the electric double layer capacitor includes an electrode, an electrolyte, a current collector, and a separator. The electrode thereof has a relatively large surface area, for example, a porous electrode. The operational principle of the electric double layer capacitor is an electro-chemical mechanism in which electricity is generated when a voltage of several volts is applied to both ends of a unit cell electrode such that ions in the electrolyte move along an electric field to be adsorbed by an electrode surface.

In general, a capacitor cell is formed by stacking unit cells, each of which is constructed by stacking a pair of electrodes with a sheet of separator disposed therebetween.

Here, the arrangement of the pair of electrodes and the separator may be easily distorted, thereby causing a short circuit and creating difficulty in the realization of greater capacitance. Also, since there is difficulty in appropriately arranging the pair of electrodes and the separator, yield rate is thereby reduced.

### SUMMARY OF THE INVENTION

An aspect of the present invention provides a chip-type electric double layer capacitor cell facilitating the realization of increased capacitance and having high yield rate and a method of manufacturing the same.

According to an aspect of the present invention, there is provided a chip-type electric double layer capacitor cell including: a separator folded to include first and second folded portions with first and second open portions formed in opposite directions by the first and second folded portions; and first and second electrodes inserted into the first and second open portions.

The first and second electrodes may have terminal lead-out portions led out in a horizontal direction with relation to the first and second folded portions.

The first and second electrodes may have terminal lead-out portions led out in a vertical direction with relation to the first and second folded portions.

The separator may be folded at the same interval according to the number of the first and second electrodes included in a stack thereof.

According to another aspect of the present invention, there is provided a method of manufacturing a chip-type electric double layer capacitor cell, the method including: folding a separator such that first and second open portions are formed in opposite directions by first and second folded portions, and arranging the first and second folded portions in a y-axis; inserting first and second electrodes into the first and second open portions in a direction of an x-axis; and compressing the separator having the first and second electrodes inserted therein.

The first and second electrodes may be inserted into the first and second open portions such that the first and second electrodes have terminal lead-out portions led out in a horizontal direction with relation to the first and second folded portions.

The first and second electrodes may be inserted into the first and second open portions such that the first and second electrodes have terminal lead-out portions led out in a vertical direction with relation to the first and second folded portions.

The first and second electrodes may be inserted into the first and second open portions such that the first and second electrodes have terminal lead-out portions led out in a vertical direction with relation to the first and second folded portions and in opposite directions.

The inserting of the first and second electrodes may be performed simultaneously.

### BRIEF DESCRIPTION OF THE DRAWINGS

The above and other aspects, features and other advantages of the present invention will be more clearly understood from the following detailed description taken in conjunction with the accompanying drawings, in which:

FIG. 1A is a schematic perspective view illustrating a chip-type electric double layer capacitor cell according to an exemplary embodiment of the present invention;

FIG. 1B is a schematic top plan view illustrating the chip-type electric double layer capacitor cell of FIG. 1A;

FIG. 1C is a schematic cross-sectional view illustrating the chip-type electric double layer capacitor cell of FIG. 1B, taken along line A-A′;

FIG. 2A is a schematic perspective view illustrating a chip-type electric double layer capacitor cell according to another exemplary embodiment of the present invention;

FIG. 2B is a schematic top plan view illustrating the chip-type electric double layer capacitor cell of FIG. 2A;

FIG. 2C is a schematic cross-sectional view illustrating the chip-type electric double layer capacitor cell of FIG. 2B, taken along line B-B′;

FIGS. 3A through 3D are cross-sectional views illustrating a method of manufacturing a chip-type electric double layer capacitor cell according to an exemplary embodiment of the present invention; and

FIGS. 4A through 4C are cross-sectional views illustrating a method of manufacturing a chip-type electric double layer capacitor cell according to another exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. It should be considered that the shapes and dimensions of elements in the drawings may be exaggerated for clarity. Throughout the drawings, the same reference numerals will be used to designate the same or like elements.

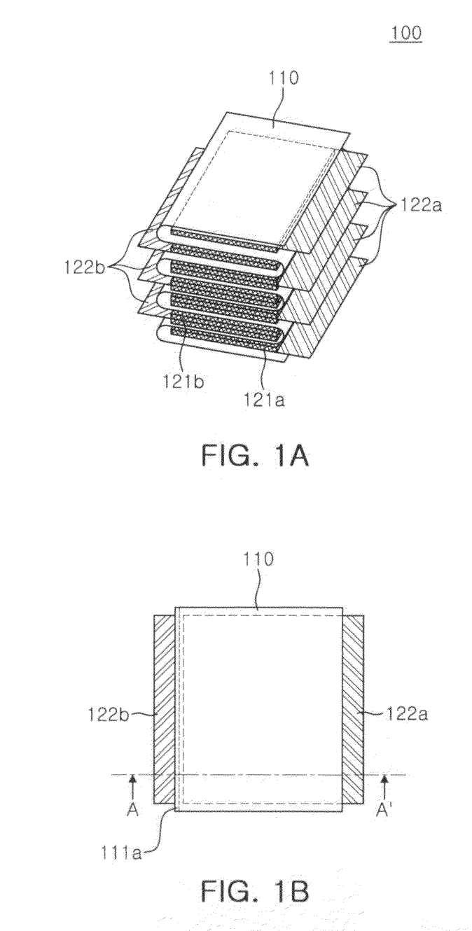

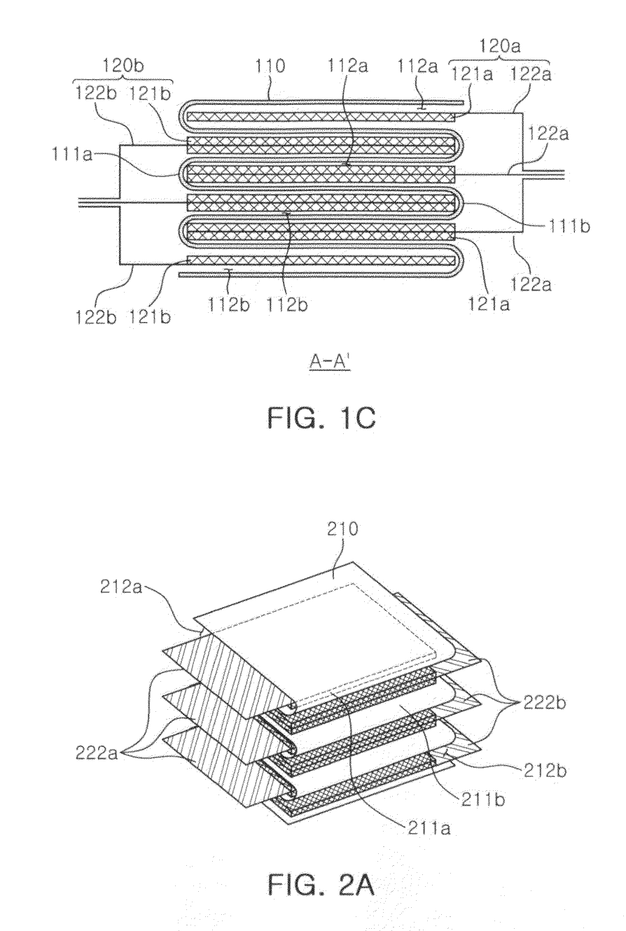

FIG. 1A is a schematic perspective view illustrating a chip-type electric double layer capacitor cell according to an exemplary embodiment of the present invention. FIG. 1B is a schematic top plan view illustrating the chip-type electric double layer capacitor cell of FIG. 1A. FIG. 1C is a schematic cross-sectional view illustrating the chip-type electric double layer capacitor cell of FIG. 1B, taken along line A-A′.

With reference to FIGS. 1A through 1C, a chip-type electric double layer capacitor cell 100 according to this embodiment includes a separator 110 and stacked first and second electrodes 120a and 120b interleaved with the separator 110.

The separator 110 may be provided as a single sheet. The separator 110 may be folded at the same interval according to the number of stacked electrodes. More specifically, the separator 110 may have first and second folded portions 111a and 111b that are folded in opposite directions. Due to the way in which the first and second folded portions 111a and 111b are arranged, first and second open portions 112a and 112b that are open in opposite directions are formed.

The material of the separator 110 is not particularly limited, as long as it may be a porous material through which ions included in an electrolyte can permeate. For example, a porous material such as polypropylene, polyethylene, or glass fiber may be used.

The plurality of first open portions 112a of the separator 110 have the respective first electrodes 120a inserted therein. First terminal lead-out portions 122a of the first electrodes 120a are led out in a horizontal direction with relation to the first folded portions 111a.

The plurality of second open portions 112b of the separator 110 have the respective second electrodes 120b inserted therein. Second terminal lead-out portions 122b of the second electrodes 120b are led out in a horizontal direction with relation to the second folded portions 111b.

The positions of the first electrodes 120a are fixed by the first folded portions 111a, respectively. Accordingly, an appropriate arrangement between the plurality of first electrodes 120a is facilitated. Also, the positions of the second electrodes 120b are fixed by the second folded portions 111b. Accordingly, an appropriate arrangement between the plurality of second electrodes 120b is facilitated. The appropriate arrangement of the first and second electrodes 120a and 120b increases the area of the facing surfaces of the first and second electrodes 120a and 120b, whereby the capacitance of the chip-type electric double layer capacitor cell 100 is increased.

Also, regions of the first terminal lead-out portions 122a of the first electrodes 120a, led out through the first open portions 112a, are blocked from the second electrodes 120b by the second folded portions 111b of the separator 110. Regions of the second terminal lead-out portions 122b of the second electrodes 120b, led out through the second open portions 112b, are blocked from the first electrodes 120a by the first folded portions 111a of the separator 110. Accordingly, a short circuit between the first and second electrodes 120a and 120b is prevented.

The first and second electrodes 120a and 120b may be formed such that electrode materials 121a and 121b are formed on first and second current collectors. The first and second current collectors may have the first and second terminal lead-out portions 122a and 122b on which any electrode material is not formed.

The electrode materials 121a and 121b are not particularly limited, and electrode materials known in the art to which the invention pertains may be used. For example, activated carbon with a relatively high specific surface area may be used.

The first and second electrodes 120a and 120b may be manufactured by adhering electrode material slurry consisting mainly of powdered activated carbon onto the first and second current collectors.

The first and second current collectors are conductive sheets for transferring an electrical signal to the first and second electrodes 120a and 120b, respectively. The first and second current collectors may be formed of a conductive polymer, a rubber sheet, or a metallic foil.

The shapes of the first and second current collectors may be properly modified in such a manner that they are connected to terminals for transferring an electrical signal to the chip-type electric double layer capacitor cell 100. For example, the first and second terminal lead-out portions 122a and 122b, led out through the plurality of first and second open portions 112a and 112b, may be brought together such that they may have a partially bent shape as shown in FIG. 1C.

Also, when the first and second electrodes 120a and 120b do not include the first and second current collectors, the first and second electrodes 120a and 120b may be manufactured by making the electrode materials into a solid-state sheet. Part of the first and second electrodes 120a and 120b becomes the first and second terminal lead-out portions 122a and 122b, respectively, and may be led out through the first and second open portions 112a and 112b.

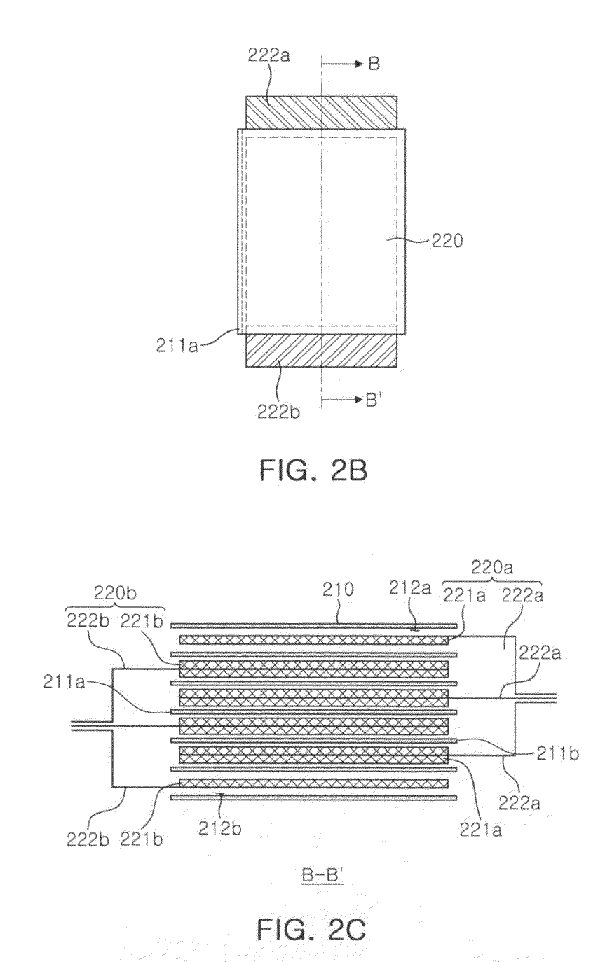

FIG. 2A is a schematic perspective view illustrating a chip-type electric double layer capacitor cell according to another exemplary embodiment of the present invention. FIG. 2B is a schematic top plan view illustrating the chip-type electric double layer capacitor cell of FIG. 2A. FIG. 2C is a schematic cross-sectional view illustrating the chip-type electric double layer capacitor cell of FIG. 2B, taken along line B-B′. A detailed description of elements different from those of the aforementioned embodiment will be provided, while a detailed description of the same elements will be omitted.

With reference to FIGS. 2A through 2C, a chip-type electric double layer capacitor cell 200 according to this embodiment includes a separator 210 and stacked first and second electrodes 220a and 220b interleaved with the separator 210.

The separator 210 may be provided as a single sheet. The separator 210 may be folded at the same interval according to the number of stacked electrodes. More specifically, the separator 210 may have first and second folded portions 211a and 211b that are folded in opposite directions. Due to the way in which the first and second folded portions 211a and 211b are arranged, first and second open portions 212a and 212b that are open in opposite directions are formed.

The plurality of first open portions 212a of the separator 210 have the respective first electrodes 220a inserted therein. First terminal lead-out portions 222a of the first electrodes 220a are led out in a vertical direction with relation to the first folded portions 211a.

The plurality of second open portions 212b of the separator 210 have the respective second electrodes 220b inserted therein.

Second terminal lead-out portions 222b of the second electrodes 220b are led out in a vertical direction with relation to the second folded portion 211b and in an opposite direction to the first terminal lead-out portions 222a.

The positions of the first electrodes 220a are fixed by the first folded portions 211a, respectively. Accordingly, an appropriate arrangement between the plurality of first electrodes 220a is facilitated. Also, the positions of the second electrodes 220b are fixed by the second folded portions 211b. Accordingly, an appropriate arrangement between the plurality of second electrodes 220b is facilitated. The appropriate arrangement of the first and second electrodes 220a and 220b increases the area of the facing surfaces of the first and second electrodes 220a and 220b, whereby the capacitance of the chip-type electric double layer capacitor cell 200 is increased.

Hereinafter, a method of manufacturing a chip-type electric double layer capacitor cell according to an exemplary embodiment of the present invention will be described in detail with reference to the accompanying drawings.

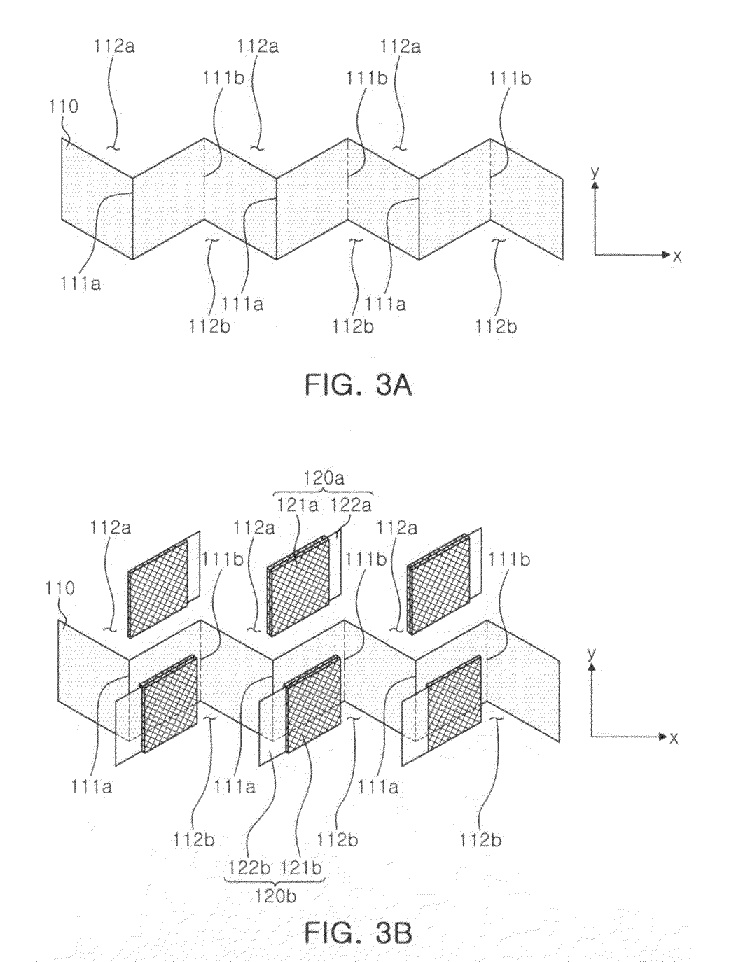

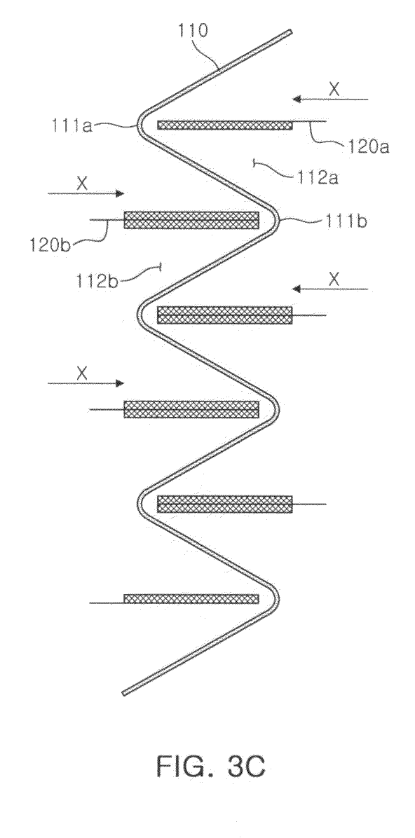

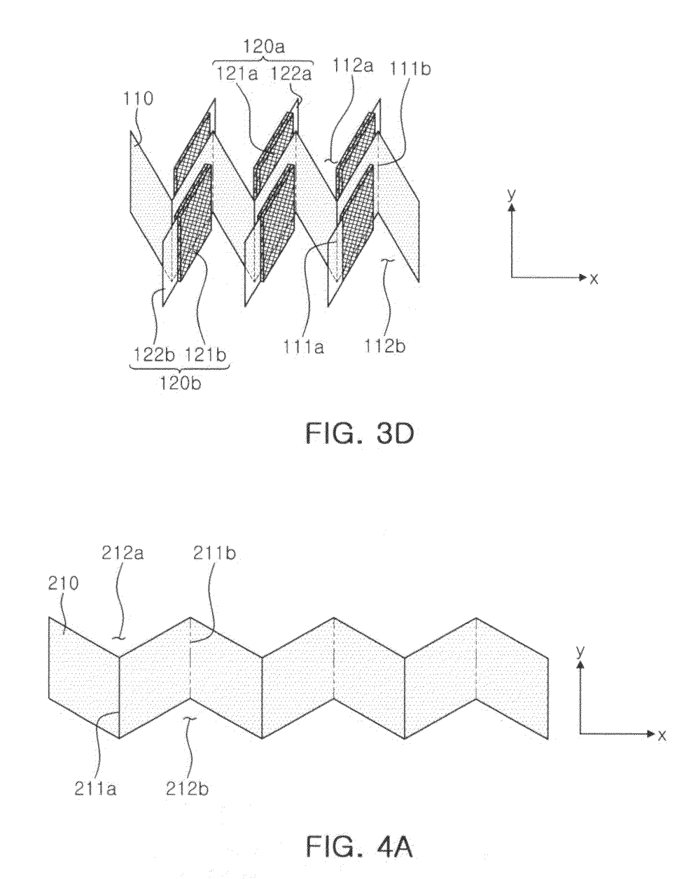

FIGS. 3A through 3D are cross-sectional views illustrating a method of manufacturing a chip-type electric double layer capacitor cell according to an exemplary embodiment of the present invention.

First, as shown in FIG. 3A, the separator 110 is folded such that the first and second folded portions 111a and 111b are arranged in opposite directions. Due to the way in which the first and second folded portions 111a and 111b are arranged, the first and second open portions 112a and 112b are formed in opposite directions. By arranging the first and second folded portions 111a and 111b of the separator 110 in a y-axis, the first and second open portions 112a and 112b are open toward an x-axis.

Next, as shown in FIGS. 3B and 3C, the first and second electrodes 120a and 120b are respectively inserted into the first and second open portions 112a and 112b in the direction of the x-axis.

Here, the first electrodes 120a may be inserted in the direction of the x-axis such that the first terminal lead-out portions 122a of the first electrodes 120a may be led out in a horizontal direction with relation to the first folded portions 111a. FIG. 3C is a top plan view of FIG. 3B.

Also, the second electrodes 120b may be inserted in the direction of the x-axis such that the second terminal lead-out portions 122b of the second electrodes 120b may be led out in a horizontal direction with relation to the second folded portions 111b.

The inserting of the first and second electrodes 120a and 120b into the first and second open portions 112a and 112b may be performed individually or simultaneously.

When the first and second electrodes 120a and 120b are inserted into the first and second open portions 112a and 112b, respectively, the inserted positions of the first and second electrodes 120a and 120b are fixed by the first and second folded portions 111a and 111b.

Also, the separator may be disposed on a planar surface in such a manner that the y-axis is to be vertical. At this time, the lower parts of the first and second electrodes 120a and 120b are supported by the planar surface so that the inserting process is facilitated. That is, the first and second electrodes 120a and 120b, when inserted, are supported by the planar surface and the positions thereof are fixed by the first and second folded portions 111a and 111b, whereby the inserting process is facilitated.

Then, as shown in FIG. 3D, the separator 110 having the first and second electrodes 120a and 120b inserted therein is compressed so that the first and second folded portions 111a and 111b are further folded. Accordingly, the chip-type electric double layer capacitor cell 100 as shown in FIGS. 1A through 1C is manufactured.

According to this embodiment, the arrangement of the first and second electrodes is facilitated, and thus the yield rate of the chip-type electric double layer capacitor cell is enhanced.

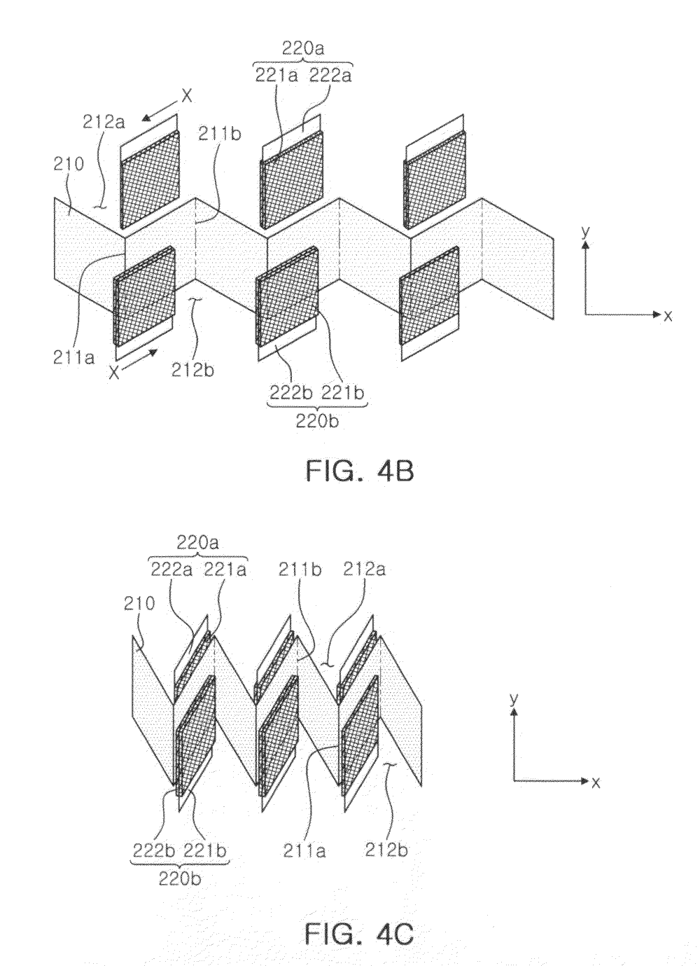

FIGS. 4A through 4C are cross-sectional views illustrating a method of manufacturing a chip-type electric double layer capacitor cell according to another exemplary embodiment of the present invention.

First, as shown in FIG. 4A, the separator 210 is folded such that the first and second folded portions 211a and 211b are arranged in opposite directions. Due to the way in which the first and second folded portions 211a and 211b are arranged, the first and second open portions 212a and 212b are formed in opposite directions. By arranging the first and second folded portions 211a and 211b of the separator 210 in a y-axis, the first and second open portions 212a and 212b are open toward an x-axis.

Next, as shown in FIG. 4B, the first electrodes 220a are inserted into the first open portions 212a in the direction of the x-axis such that the first terminal lead-out portions 222a of the first electrodes 220a are led out in a vertical direction with relation to the first folded portions 211a. Also, the second electrodes 220b are inserted into the second open portions 212b in the direction of the x-axis such that the second terminal lead-out portions 222b of the second electrodes 220b are led out in a vertical direction with relation to the second folded portions 211b.

The second terminal lead-out portions 222b may be inserted in the vertical direction with relation to the second folded portions 211b and in an opposite direction to the first terminal lead-out portions 222a.

The inserting of the first and second electrodes 220a and 220b into the first and second open portions 212a and 212b may be performed individually or simultaneously.

When the first and second electrodes 220a and 220b are inserted into the first and second open portions 212a and 212b, respectively, the inserted positions of the first and second electrodes 220a and 220b are fixed by the first and second folded portions 211a and 211b.

Then, as shown in FIG. 4C, the separator 210 having the first and second electrodes 220a and 220b inserted therein is compressed so that the first and second folded portions 211a and 211b are further folded. Accordingly, the chip-type electric double layer capacitor cell 200 as shown in FIGS. 2A through 2C is manufactured.

According to this embodiment, the arrangement of the first and second electrodes is facilitated, and thus the yield rate of the chip-type electric double layer capacitor cell is enhanced.

As set forth above, in a chip-type electric double layer capacitor cell according to exemplary embodiments of the invention, the positions of first and second electrodes are fixed by first and second folded portions of a separator. Accordingly, the appropriate arrangement of the plurality of first and second electrodes is facilitated to thereby increase the capacitance of the chip-type electric double layer capacitor cell.

Also, first terminal lead-out portions of the first electrodes are blocked from the second electrodes by the second folded portions of the separator, and thus a short circuit between the first and second electrodes is avoided.

In addition, in a method of manufacturing a chip-type electric double layer capacitor cell according to exemplary embodiment of the invention, the arrangement of first and second electrodes is facilitated to thereby enhance the yield rate of the chip-type electric double layer capacitor cell.

While the present invention has been shown and described in connection with the exemplary embodiments, it will be apparent to those skilled in the art that modifications and variations can be made without departing from the spirit and scope of the invention as defined by the appended claims.

What is claimed is:

1. A chip-type electric double layer capacitor cell comprising:
a separator folded to include first and second folded portions with first and second open portions formed in opposite directions by the first and second folded portions; and
first and second electrodes inserted into the first and second open portions.

2. The chip-type electric double layer capacitor cell of claim 1, wherein the first and second electrodes have terminal lead-out portions led out in a horizontal direction with relation to the first and second folded portions.

3. The chip-type electric double layer capacitor cell of claim 1, wherein the first and second electrodes have terminal lead-out portions led out in a vertical direction with relation to the first and second folded portions.

4. The chip-type electric double layer capacitor cell of claim 1, wherein the separator is folded at the same interval according to the number of the first and second electrodes included in a stack thereof.

5. A method of manufacturing a chip-type electric double layer capacitor cell, the method comprising:
folding a separator such that first and second open portions are formed in opposite directions by first and second folded portions, and arranging the first and second folded portions in a y-axis;
inserting first and second electrodes into the first and second open portions in a direction of an x-axis; and
compressing the separator having the first and second electrodes inserted therein.

6. The method of claim 5, wherein the first and second electrodes are inserted into the first and second open portions such that the first and second electrodes have terminal lead-out portions led out in a horizontal direction with relation to the first and second folded portions.

7. The method of claim 5, wherein the first and second electrodes are inserted into the first and second open portions such that the first and second electrodes have terminal lead-out portions led out in a vertical direction with relation to the first and second folded portions.

8. The method of claim 5, wherein the first and second electrodes are inserted into the first and second open portions such that the first and second electrodes have terminal lead-out portions led out in a vertical direction with relation to the first and second folded portions and in opposite directions.

9. The method of claim 5, wherein the inserting of the first and second electrodes is performed simultaneously.
